(19) United States
(12) Patent Application Publication
(10) Pub. No.: US 2012/0186992 A1
(43) Pub. Date: Jul. 26, 2012

(54) ELECTROCOAGULATION FOR TREATING LIQUIDS

(76) Inventor: Abderrazak Berrak, Sherbrooke (CA)

(21) Appl. No.: 13/310,106

(22) Filed: Dec. 2, 2011

Related U.S. Application Data
(60) Provisional application No. 61/435,698, filed on Jan. 24, 2011.

(51) Int. Cl. C02F 1/461; C25D 17/10

(52) U.S. Cl. 205/687; 204/225

(57) ABSTRACT

A method, a system and a kit for removing colloid contaminants from a fluid by destabilization thereof with addition of kinetic energy thereto is provided, the method to overcome the energetic barrier preventing an efficient fluid-solid separation comprises injecting the colloidal fluid containing contaminants in an electrolytic system including an electrocoagulation module comprising an anode and a cathode, the anode and the cathode being adapted to be electrically connected to perform electrolysis of the fluid, providing an electric current, between the anode and the cathode, to form electro-coagulated contaminants flocs in the agitated fluid, separating the electro-coagulated flocs from the fluid, and extracting the fluid from the electrolytic system.

### CROSS-REFERENCE

The present United States patent application claims priority from U.S. provisional patent application No. 61/435,698, filed Jan. 24, 2011, entitled ELECTROCOAGULATION FOR TREATING LIQUIDS, which is hereby incorporated by reference in its entirety.

### FIELD OF THE INVENTION

This invention relates to a method for treating liquid with electrocoagulation. More precisely, the present invention relates to a method, a system and an apparatus for treating colloidal solutions with electrocoagulation in an agitated environment.

### BACKGROUND OF THE INVENTION

Nowadays water pollution is a significant issue and efforts are made to improve wastewater treatments. Water treatment processes commonly used are mainly based mechanical filtration and on bacterial activity. Many microorganisms belonging to five different classes (e.g. bacteria, virus, protozoa, fungi and helminth) are found in wastewater and wastewater process treatments. Disinfection processes are divided into two main groups, namely the physical and chemical processes (Metcalf and Eddy, 2003). The physical processes include: electromagnetic radiation, ultrasonic waves, heat, visible light and ultraviolet (UV), ionizing radiation (gamma and X), electron beam and electric current. Chemical methods use different compounds including: halogens and their derivatives (Cl₂, Br₂, I₂, HOCl, OCl, ClO₂, HOBr, HOI, . . . ), oxygenated compounds and highly oxidizing (ozone, hydrogen peroxide, phenols, alcohols, percarbonates and persulfates, peracetic acid, potassium permanganate, . . . ), dyes, quaternary ammonium compounds, acids and bases as well as enzymes. Some contaminants, like colloidal contaminants, are difficult to separate from liquid because of their electrical barrier.

Electrocoagulation was already proposed in the late 19th and early 20th century. The use of electrocoagulation with aluminum and iron was patented in 1909 in the United States (Stuart, 1947; Bonilla, 1947, Vik et al. 1984). Matteson et al. (1995) described an “electronic coagulator” in the 1940s, using aluminum anodes, and in 1956 a similar process in Great Britain using, in turn, iron anodes.

Coagulation is essentially to neutralize, or reduce, the electric charge of colloids and hence promote the aggregation of colloidal particles. To destabilize a suspension it is necessary that the attractive forces between particles are greater than the repulsive forces thereof. Attractive forces are mainly van der Weals forces, which act at a short distance thereof. In general, the total energy that controls the stability of the energy dispersion comprises attractive van der Weals energy of repulsion at short distance, the electrostatic energy and energy due to the steric effect of molecules solvent.

Coagulation can be done by chemical or electrical means. Alun, lime and/or polymers have been used as chemical coagulants. Chemical coagulation is becoming less popular today because of high costs associated with the chemical treatments of a significant volume of sludge and hazardous heavy metals such as metal hydroxides generated thereof in addition to the cost of chemical products needed for coagulation itself. Chemical coagulation has been used for decades.

Although the electrocoagulation mechanism resembles chemical coagulation, although, some differences benefit electrocoagulation. Indeed, electrocoagulated flocs differ from those generated by chemical coagulation. Flocs created with the electrocoagulation process tend to contain less bound water, are more resistant to shearing and are more easily filterable.

Flocs are created during the electrocoagulation water treatment with oxydo-reduction reactions. Currents of ions and charged particles, created by the electric field, increase the probability of collisions between ions and particles of opposite signs that migrate in opposite directions. This phenomenon allows the aggregation of suspended solids to form flocs.

The electrolytic reactions that take place at the electrodes are accompanied by production of micro bubbles of hydrogen (at the cathode) and oxygen (at the anode). These micro bubbles heading up will result in an upward movement of the flocs formed thereof that are recovered at the surface (this mechanism is named flotation).

The complexity of the mechanisms involved in the process of electrocoagulation in the treatment of water is not well scientifically elucidated (Yusuf et al., 2001). There are various features of the mechanism of the process and the geometry, or design, of the reactor in the literature. The different physico-chemical treatment, the shape of the reactor and the shape and size of electrodes affect the performance of the treatment (M. Bennajah, 2007). The wide variety of processing parameters reported in the literature and the lack of scientific data for efficient model processing and optimal processing conditions translate into a lack of development in this field. At this time, electrocoagulation is still problematic and therefore not popular (Holt et al. 2002, 2006).

The existence of an electric current in a body of water implicitly requires Faraday reactions surrounding the electrodes. The formation of chemical gradients depends on the electrolysis magnitude. The consequences of chemical reactions become more pronounced and significant in the prolonged application of electrokinetic. The effects include electrolysis of water with the simultaneous development of pH gradients and the transfer of electrolytic dissolution of the anode producing metal ions (Fe³⁺, Al³⁺, Mg²⁺, etc.) or cations of the electrolyte from the anode to the cathode. Chemical reactions can, in ion exchange or precipitation, form new mineral phases for cleaning water for instance.

At the cathode, the main reaction is:

4H₂O+4e⁻→2H₂+4OH⁻ (Equation 1)

The increase in hydroxyl ions can increase the precipitation of metal hydroxide. The pH of the cathode's region is basic. The following equations describe the chemical reactions at the anode:

2H₂O→O₂+4H⁺+4e⁻ (Equation 2)

If the anode is made of magnesium:

Mg→Mg²⁺+2e⁻ (Equation 3)

It is noted that twice as many water molecules are electrolysed at the cathode compared to the anode for the same quantity of electricity.

Legacy electrocoagulation systems are associated with several issues. One of the issues is related to gas accumulation that damages the recipient. Other issues can include a wrong alignment and distance between the electrodes, the use of wrong electrode materials, a wrong electrode geometry, the thickness of the electrodes is not proper and the amount of energy used is not suited for the treatment of a specific fluid. Also, legacy electrocoagulation systems are not convenient for commercial or industrial uses.

Therefore, there exists a need in the art for an improved method, system and apparatus for treating a liquid over the existing art. There is a need in the art for such a method, system and apparatus for treating a liquid that can be easily installed, economically manufactured and operated. And there is a very perceptible need for an improved method, system and apparatus for treating wastewater over the existing art.

### SUMMARY OF THE INVENTION

The present invention alleviates one or more of the drawbacks of the background art by addressing one or more of the existing needs in the art.

Accordingly, the present invention provides a method of treating liquid, especially, but not limited to, water, with electrocoagulation, using magnesium or other materials, in an agitated environment, in accordance with at least one embodiment of the invention.

The present invention provides a method and an apparatus for destabilizing colloidal solutions using turbulent fluid to overcome the energetic barrier of the colloidal solution, facilitate colloid agglomeration and facilitate solid-fluid separation, in accordance with at least one embodiment of the invention.

The present invention provides a method and an apparatus for treating industrial wastewater, food processing wastewater, dairy production greywater, leachate, domestic greywater, the reduction of ammonia nitrogen and ortho-phosphate and reduction of soluble chemical oxygen demand (hereinafter COD) with electrocoagulation in accordance with at least one embodiment of the invention.

The present invention provides a method and an apparatus for treating liquid with electrocoagulation that agglomerate and filter colloidal solutions in accordance with at least one embodiment of the invention.

The present invention provides a method of treating liquid with electrocoagulation that injects magnesium in the liquid in accordance with at least one embodiment of the invention.

The present invention provides a method and an apparatus for treating liquid with electrocoagulation that provides severe electrolytic conditions capable of attacking organic molecules responsible of soluble DCO, inter alia, phenols in accordance with at least one embodiment of the invention.

The present invention provides an apparatus for treating liquid with electrocoagulation provided with a modular electrocoagulation apparatus that can be easily installed and/or replaced in a process in accordance with at least one embodiment of the invention.

The present invention provides an apparatus for treating liquid with electrocoagulation that uses an electrocoagulation module including an anode module and a cathode module in accordance with at least one embodiment of the invention.

The present invention provides an apparatus for treating liquid with electrocoagulation provided with a modular anode that can be easily replaced, like a cartridge in accordance with at least one embodiment of the invention.

The present invention provides an apparatus for treating liquid with electrocoagulation that uses a movable anode adapted to add kinetic energy in the liquid to treat in accordance with at least one embodiment of the invention.

The present invention provides an apparatus for treating liquid with electrocoagulation that uses an anode module including of a plurality of anodic materials in accordance with at least one embodiment of the invention.

The present invention provides an apparatus for treating liquid with electrocoagulation that uses an anode module including of a plurality of anodes equally disposed thereabout in accordance with at least one embodiment of the invention.

The present invention provides an apparatus for treating liquid with electrocoagulation that uses an anode module including a plurality of anodes geometrically disposed thereabout in accordance with at least one embodiment of the invention.

The present invention provides a method of treating liquid with electrocoagulation that uses an anode module made of a plurality of replaceable anodes adapted to react and agglomerate different types of contaminants in accordance with at least one embodiment of the invention.

The present invention provides a method of treating liquid with electrocoagulation that uses an anode module including a plurality of anodes having various geometrical section like, but not limited to, oval, conical, frustoconical, square, round, triangular, . . . to react in various fashion with cathode to agglomerate different types of contaminants, each anode being adapted to be consumable or inert, in accordance with at least one embodiment of the invention.

The present invention provides a method of electro destruction and weakening of refractory molecules responsible for soluble COD. Electro destruction is an oxidation process assisted with the action of electric current that weakens refractory molecules that are then easier to destroy. Generally, they are attacked by the action of oxidizing agents that can be added (adding hydrogen peroxide or per carbonate) or generated in situ by the action of electric current on acids such as sulphuric acid or simply water (production of free radicals and persulfates) in accordance with at least one embodiment of the invention.

The present invention provides a method of electro destruction and reduction of toxic molecules such as polychlorinated biphenyls (PCBs), with or without chemical assistance in accordance with at least one embodiment of the invention.

The present invention provides an electrocoagulation module functioning on the principle of a sacrificial anode (Al, Fe, Mg, Ca . . . ), subjected to the application of a potential difference between the anode and a cathode. The cathode can either be made of steel or other metal identical to the anode depending of the fluid parameters and under the application of a potential difference that causes an agglomeration of particles in the fluid around the released ion. The particles formed thereof are evacuated with the flow of fluid in accordance with at least one embodiment of the invention.

The present invention provides a method of electro-synthesis and preparation of calco-magnesio hydroxyled and fluorided apatite Ca₁₀₋ₓMgₓ(PO₄)₆F₂, Ca₁₀₋ₓMgₓ(PO₄)_{6OH}OH₂. Apatites are a family of isomorphs compounds of fluorapatite: Ca₁₀(PO₄)6F₂.

The present invention provides a method for electro-synthesis apatites using a synthetic chemical that is a reacted solution containing Mg²⁺ and Ca²⁺ with a solution containing the PO₄³⁻. The method is a synthesis in which the electrolysis process injects Mg²⁺ through the application of electric current in accordance with at least one embodiment of the invention.

The present invention provides a combination of electrocoagulation and mechanical agitation of the anodes for better performance. Agitation of the anode can be made in a circular fashion by rotating or reciprocating motion and can also be done inside or outside the electrocoagulation module in accordance with at least one embodiment of the invention.

The present invention provides a method for dephosphating industrial wastewater, municipal wastewater and food processing wastewater by formation of Mg₃(PO₄)₂ complex in accordance with at least one embodiment of the invention.

The present invention provides a method and an apparatus providing a pre-thickened industrial liquid sludge, municipal liquid sludge, and food processing liquid sludge with 1% initial dryness to more than 8% final dryness without adding polymer therein. Raw sludges have a dry content of 1-2% and should be pre-thickened with polymers before being dehydrated. The addition of polymers increases the amount of sludge and makes them viscous. A pre-thickening with electrocoagulation-electro flotation would decrease or eliminate the amount of polymer to be added in accordance with at least one embodiment of the invention.

The present invention provides a method and an apparatus capable of heat recovery in cases of heat-polluted industrial wastewater treatment. The present invention is an efficient method to treat this type of wastewater with the possibility to recover at least a portion of the electrocoagulation exothermic energy, in accordance with at least one embodiment of the invention.

The present invention provides a method and an apparatus for applying an electric current to procure bacterial reduction that can be achieve as follows: disintegration of cell wall (that causes osmotic lysis); membrane permeability modification; modification of intercellular constituents; nucleic acids alteration; protein synthesis interference; abnormal redox processes induction; and enzyme activity inhibition in accordance with at least one embodiment of the invention.

The present invention provides a kit comprising an anode module, a cathode module adapted to be operatively secured to the anode module, an anode agitation module, a fluid agitation module and at least one replaceable anode adapted to be mounted to the anode module in accordance with at least one embodiment of the invention.

The present invention provides a method of treating a colloidal fluid to remove contaminants contained therein, the method comprising injecting the colloidal fluid containing contaminants in an electrolytic system including an electrocoagulation module comprising an anode; and a cathode, the anode and the cathode being adapted to be electrically connected to perform electrolysis of the fluid; providing an electric current, between the anode and the cathode, to form electro-coagulated contaminants flocs in the fluid; separating the electro-coagulated flocs from the fluid; and extracting the fluid from the electrolytic system in accordance with at least one embodiment of the invention.

The present invention provides a modular electrolysis system for treating fluid for removing colloid contaminants contained therein, the modular electrolysis system comprising an electrocoagulation module including an inlet and an outlet, the electrocoagulation module being adapted to include a removable anode module therein and a cylindrical cathode module for performing electrolysis of the fluid in the electrocoagulation module in accordance with at least one embodiment of the invention.

An electrolysis kit for treating a fluid to remove colloid contaminants contained therein, the kit comprising an electrolytic module; an anode module adapted to be operatively inserted in the electrolytic module; and at least one anode adapted to be assembled to the anode module, the anode material being defined to produce one electrolytic process selected from electrocoagulation and electro-floatation.

Other objects and further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

Additional and/or alternative advantages and salient features of the invention will become apparent from the following detailed description, which, taken in conjunction with the annexed drawings, disclose preferred embodiments of the invention.

### BRIEF DESCRIPTION OF THE DRAWINGS

Referring now to the drawings which form a part of this original disclosure:

FIG. 1 is a schematic illustration of a modular electrolysis apparatus 10 in accordance with at least one embodiment of the invention;

FIG. 2 is a schematic illustration of a modular electrolysis apparatus in accordance with at least one embodiment of the invention;

FIG. 3 is a schematic illustration of a modular electrolysis apparatus in accordance with at least one embodiment of the invention;

FIG. 4 is a schematic illustration of a modular electrolysis apparatus in accordance with at least one embodiment of the invention;

FIG. 5 is a schematic illustration of a modular electrolysis apparatus in accordance with at least one embodiment of the invention;

FIG. 6 is an illustrative flow chart of an exemplary series of steps in accordance with at least one embodiment of the invention;

FIG. 7 is a schematic illustration of a modular electrolysis apparatus in accordance with at least one embodiment of the invention;

FIGS. 8a), b) and c) is a schematic illustration of an anode module in accordance with at least one embodiment of the invention;

FIGS. 9a), b) and c) is a schematic illustration of an anode module in accordance with at least one embodiment of the invention;

FIGS. 10A and 10B are schematic illustrations of possible anodes configurations on the anode module in accordance with embodiments of the invention;

FIG. 11 is an illustrative fluid flow illustration of an exemplary electrolysis system in accordance with at least one embodiment of the invention;

FIG. 12 is an illustrative illustration of an exemplary electrolysis system in accordance with at least one embodiment of the invention;

FIG. 13 is an illustrative fluid flow illustration of an exemplary electrolysis system in accordance with at least one embodiment of the invention;

FIG. 14 is an illustrative exemplary decanter module in accordance with at least one embodiment of the invention;

FIG. 15 is an illustrative exemplary decanter module in accordance with at least one embodiment of the invention; and

FIG. 16 is an illustrative exemplary decanter module in accordance with at least one embodiment of the invention.

### DETAILED DESCRIPTION OF PREFERRED EMBODIMENTS

A preferred embodiment of the present invention is described bellow with reference to the drawings.

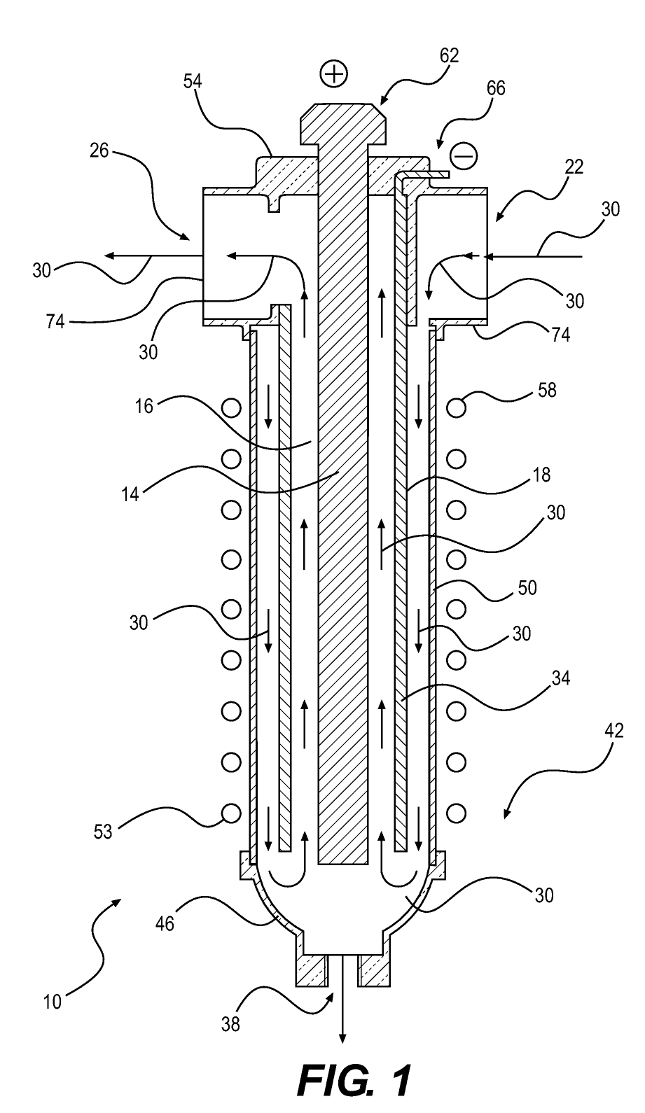

An exemplary electrocoagulation module 10 is illustrated in FIG. 1 with a section view allowing a better view of its construction. The electrocoagulation module 10 comprises an anode module 14 and a cathode module 18 adapted to interact in an electrolytic process producing electrocoagulation of undesirable colloidal particles. The electrocoagulation module 10 of the present embodiment includes an inlet 22 and an outlet 26 configured to respectively receive and extract the fluid to and from the electrocoagulation module 10. The fluid, once introduced in the electrocoagulation module 10, follows a path or a fluidic circuit configured to put the fluid in communication with the electrolytic process that is produced in the electrocoagulation module 10. In the present example, the fluid follows a path identified by a series of arrows 30 defined by internal walls 34. A pump, which is not illustrated in FIG. 1, pushes the fluid through the electrocoagulation module 10. An opening 38 disposed on a bottom portion 42 of the electrocoagulation module 10 is normally closed with a plug (not illustrated) to prevent the fluid to exit the electrocoagulation module 10. The opening 38 can be opened to remove the fluid from the electrocoagulation module 10 to purge the electrocoagulation module 10 for maintenance purposes, for instance. The electrocoagulation module 10 can also be purged to remove particles and debris. A larger closure member 46 is used to close the bottom portion of the electrocoagulation module 10 lower body 50. The closure member 46 can be optionally removed to provide a larger access in the electrocoagulation module 10. The lower body 50 can threadedly engage the upper body 54 and be removed from the upper body 54, if desirable.

Still referring to FIG. 1, the closure member 46 is located at the lower portion of the electrocoagulation module 10 to receive particles therein. The cathode module 18 is bottomless and allows the particles to drop in the closure member 46 acting as a particles-receiving member 46. The removable particles-receiving member 46 is preferably disposed in the center of the cathode module 18 as illustrated in the present embodiment and is used for removing decanted particles from the cathode module 18. The opening 38 in the closure member 46 can alternatively be used to inject gas, like air, or liquids for further conditioning the liquid in the electrocoagulation module 10 and/or influence the electrocoagulation process inside the cathode module 18.

The electrocoagulation module 10 further includes body portions 50, 54 that can optionally include insulating material to prevent heat transfer with the environment. Conversely, the electrocoagulation module 10 might be equipped with heating/cooling elements 58 to keep the electrocoagulation apparatus 10 at a predetermined operating temperature. The upper body 54 of an embodiment can be made of an insulating material preventing heat transfer between the inside of the electrocoagulation module 10 and the outside of the electrocoagulation module 10. The lower body 50 of the embodiment illustrated in FIG. 1 is made of a material that is less insulating the electrocoagulation module 10. Heating or cooling elements 58 are disposed, for example, in a spiral around the lower body 54 to either heat or cool the lower body 50. The heating or cooling elements 58 can use a fluid circulating in a tubular system or electric elements in contact with, or nearby, the lower body 50. Another embodiment is using the upper body 54 to transfer heat to/from the electrocoagulation module 10 in cooperation or not with the lower body 50.

Still referring to the embodiment of FIG. 1, the anode module 14 is secured to the upper body 54 and extends above the upper body 54 to allow electrical connection 62 thereto. The cathode module 18 of the present embodiment is also secured to the upper body 54 and extends therefrom 66 to allow electrical connection thereto. A power supply (not illustrated) is connected to the cathode module 18 to provide negative power thereof. Electrical polarity reversal is provided when desired to avoid passivation of the anode module 14 and the anodes 16 secured thereon. Insulators may be placed between two adjacent electrodes to prevent short circuits thereof. The cathode 18 and the anodes 16 are subjected to DC current. One skilled in the art can also appreciate that the upper body 54 is made of an insulating material to prevent establishing an electrical connection between the cathode 18 and the anode 14 modules.

The anode module 14 can be made of soluble or inert materials. The cathode module 18 can be made of steel, aluminum, stainless steel, galvanized steel, brass or other materials that can be of the same nature as the anode module 14 material or having an electrolytic potential close to the electrolytic potential of the anode 16. The cathode module 18 of the present embodiment has a hollowed cylindrical shape, fabricated of sheet material, and can be equipped with an optional lower frustoconical portion (not illustrated in FIG. 1). The inter electrode distance of an embodiment of the invention is about between 8-25 mm and preferably 10 mm for electro floatation and 20 mm for electrocoagulation. The interior of the cathode module 18 electrically interacts with the outside of the anode module 14. The electrocoagulation module 10 internal wall includes non-conductive material, like polymer, in an embodiment of the invention. The cathode module 18 could alternatively serve as a reservoir, or reactor, at the same time thus holding the liquid to treat therein in other embodiments. The cathode module 18 can be made of a material different from the anode material 16 or can alternatively be made of the same material, like, for instance, magnesium.

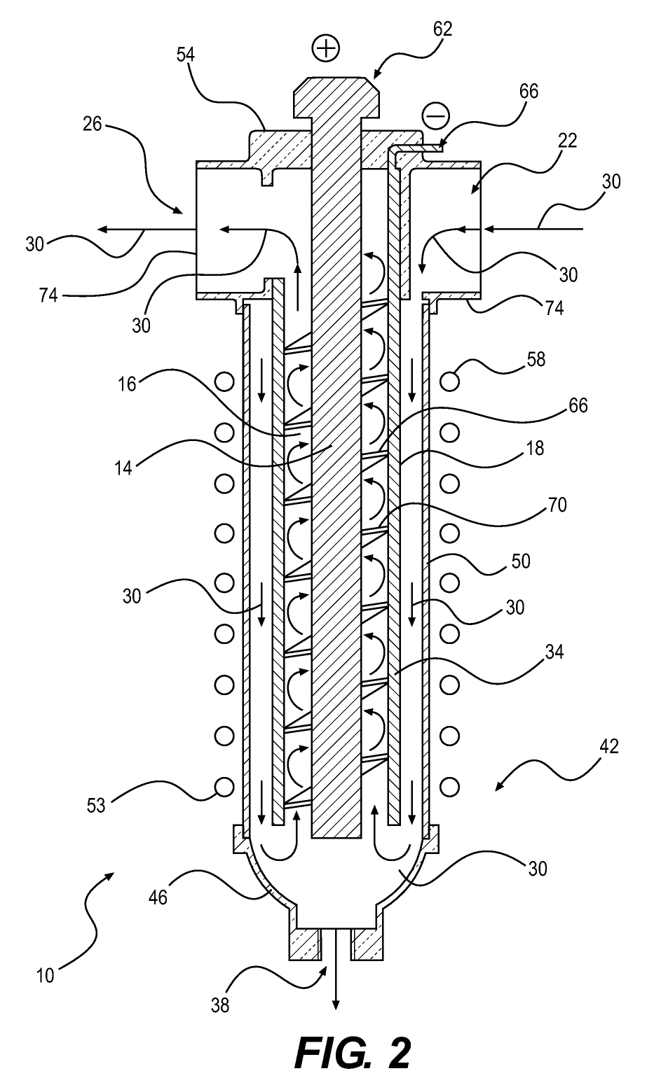

The size and the available active surface area of the cathode module 18 can be adapted to various conditions without departing from the scope of the present invention. The surface ration of the cathode/anode can be identical or vary to about 1.5. The cathode module 18 of other embodiments can alternatively be oval or conical; its diameter expending upward or downward. The electrocoagulation module 10 can include therein an optional fluid agitator module 66 adapted to apply kinetic energy to the fluid contained in the electrocoagulation module 10 by moving or vibrating the fluid in the electrocoagulation module 10 as it is illustrated in the embodiment depicted in FIG. 2.

As mentioned above, the movement of the fluid increases the kinetic energy contained therein to destabilize the colloidal solution. This can be achieved by turbulently injecting the fluid in the electrolytic module (the speed and tangential injection of the fluid are possible ways to create turbulences in the fluid). The electrocoagulation module 10 embodied in FIG. 2 is substantially similar to the electrocoagulation module 10 embodied in FIG. 1 with the difference that the electrocoagulation module 10 in FIG. 1 is equipped with a fluid agitator module 66. The fluid agitator module 66 in this embodiment is a spiral shaped protrusion member 70 that is secured to the anode module 14. The movement of the fluid between the anode module 14 and the cathode module 18 is intensified by the protrusion member 70, which influences the electrolytic process. The anode module 14 of an alternate embodiment that is not illustrated in FIG. 1 and FIG. 2 could be rotatably secured to the upper body 54 of the electrocoagulation module 10 and be rotated by an external motor to rotate the anode and the protrusion members secured thereon to apply additional kinetic energy to the fluid as it will be discussed below. As it is illustrated in FIG. 1 and FIG. 2, the anode module 14 is preferably centered inside the electrocoagulation module 10 and preferably located at equal distance from the cathode module 18.

The electrocoagulation module 10 of FIG. 1 and FIG. 2 further comprises a pair of electrocoagulation module connectors 74 adapted to operatively install the electrocoagulation module 10 in a larger fluid treatment process, as it will be discussed in mode details below. The electrocoagulation module 10 can removably be mounted in series, or in parallel, in the fluid treatment process. This way, the electrocoagulation module 10 can easily be added, maintained, replaced and/or removed from the fluid treatment process.

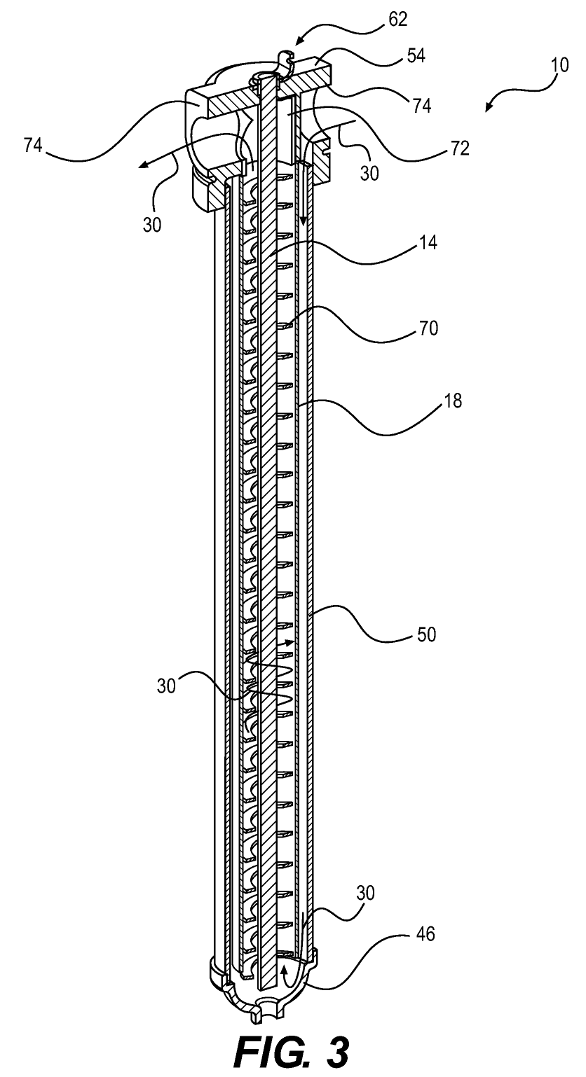

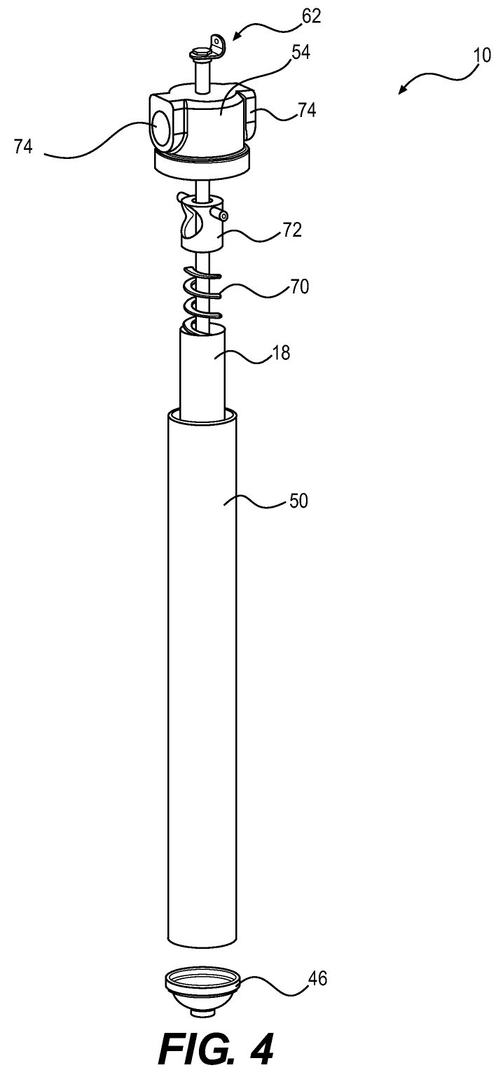

FIG. 3 and FIG. 4 illustrates additional views of the electrocoagulation module 10 equipped with a spiral protrusion member 70. One can appreciate from FIG. 3 and FIG. 4 that a fluid distributor 72 can be installed inside the electrocoagulation module 10 to channel the entering fluid downward between the cathode module 18 and the lower body 50 to make the fluid raise back between the anode module 14 and the cathode module 18 before it exits the electrocoagulation module 10 through the opening defined therein. One can appreciate from FIG. 3 that the spiral protrusion member 70 is substantially perpendicular to the anode module 14 and is used to add kinetic energy to the fluid passing along by adding turbulences. In an embodiment of the invention, the fluid is pushed in the electrocoagulation module 10 and the sole movement of the fluid in respect with the static spiral protrusion member 70 increases the energy in the fluid that augment the number of shocks that can lead to a more rapid agglomeration of particles therein.

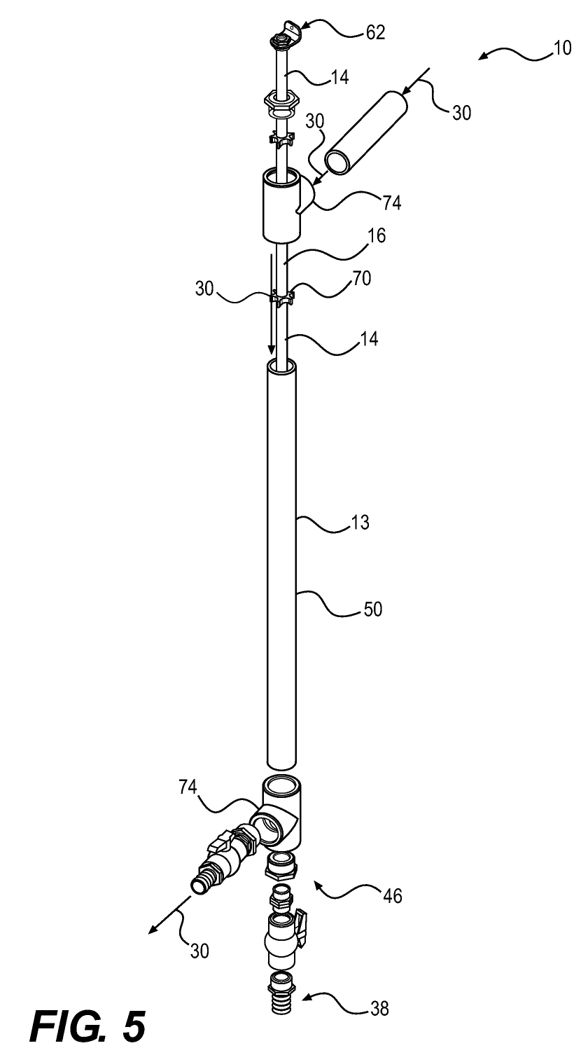

Moving now to FIG. 5 illustrating another embodiment of a simplified electrocoagulation module 10 having a rod-type anode module 14 disposed in an hollowed cathode module 18 also used as a lower body 50 in which flows the fluid to be treated. Small protrusion members 70 are disposed on the anode module 14 to agitate the fluid passing nearby in the electrocoagulation module 10 according to the fluid path identified by arrows 30.

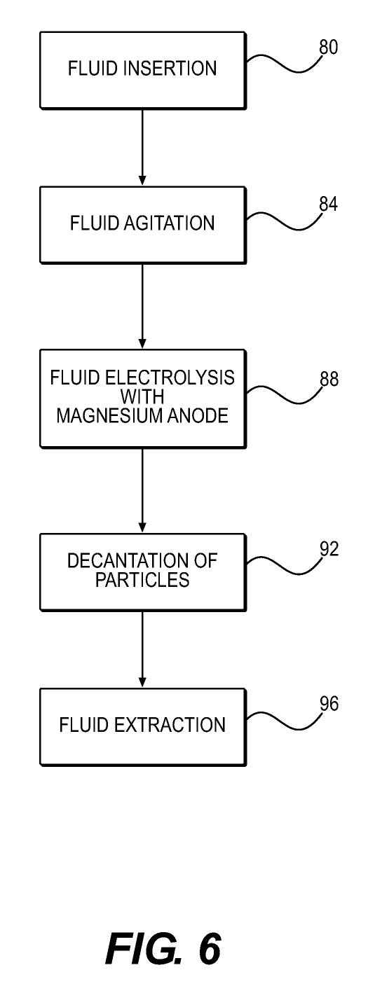

As best seen in FIG. 6, a typical series of steps are illustrated for using electrocoagulation to flocculate particles in accordance with an embodiment of the invention. Firstly there is insertion of a fluid 80 in the electrocoagulation module 10 and agitation of the fluid 84 with the anodes 16 movements increases the electrocoagulation speed. The fluid electrolysis 88 with an exemplary magnesium anode 16 begins. It has to be noted that a magnesium anode is used in the present illustrative embodiment although other anodic materials could be used as explained above. The fluid is subjected to an electric current and electrolysis is made between the cathode module 18 and the anodes 16 to increase the size of the particles contained in the fluid. The particles are then decanted 92 and/or filtered and the treated fluid is extracted from the electrocoagulation module 10.

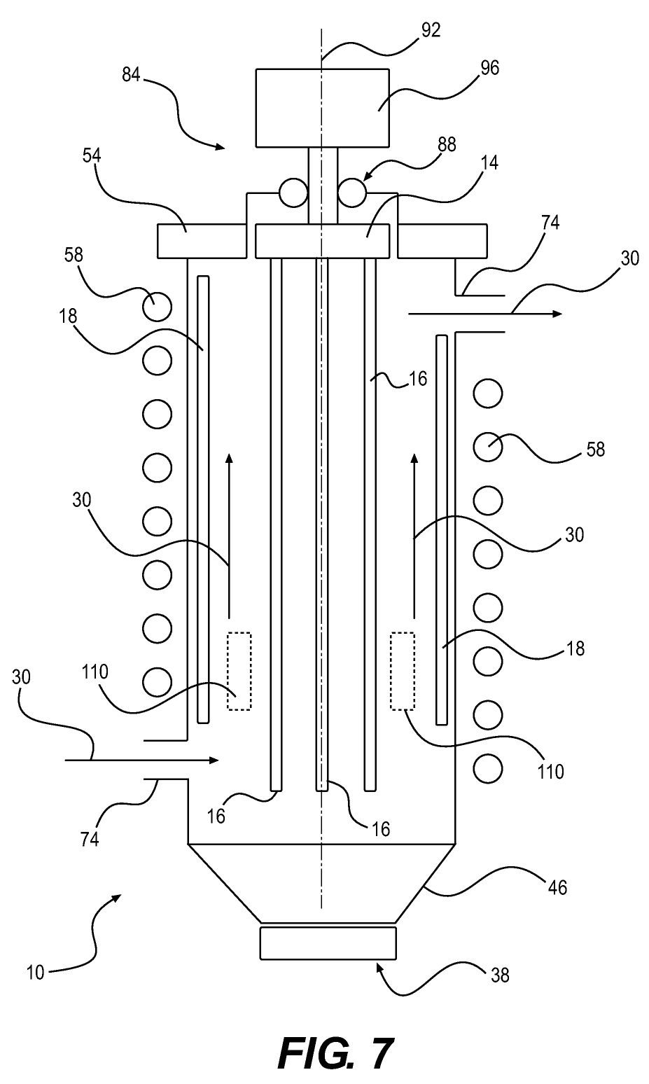

Referring to FIG. 7, the electrocoagulation module 14 might contains an optional fluid agitator module 110 to further agitate the fluid in the cathode module 14 and thus increase the kinetic energy of the fluid. The fluid agitator module 110 can be mechanical and adapted to mechanically agitate the fluid. The fluid agitator module 110 can alternatively be electrically actuated with a specific frequency in a form of ultra sounds.

The upper body 54 of the electrocoagulation module 10 embodied in FIG. 7 includes an anode module-receiving portion 84 adapted to receive therein a rotatable anode module 14. The anode module receiving portion 84 of the illustrated embodiment is provided with a bearing member 88 adapted to allow a rotation or a pivotal motion of the anode module 14 inside the electrocoagulation module 10 about an anode module vertical axis 92 and in respect with the cathode module 18 to add kinetic energy to the fluid in the electrocoagulation module 10. A motor 96, operatively connected to the anode module 18, provides the rotation and/or the pivotal of the anode module 18. As it can be appreciated, the anode module receiving-portion 84 is provided with seals (e.g. “O”-rings, not illustrated) and a fastening mechanism (not illustrated) to properly seal and secure the anode module 14 in the electrocoagulation module 10.

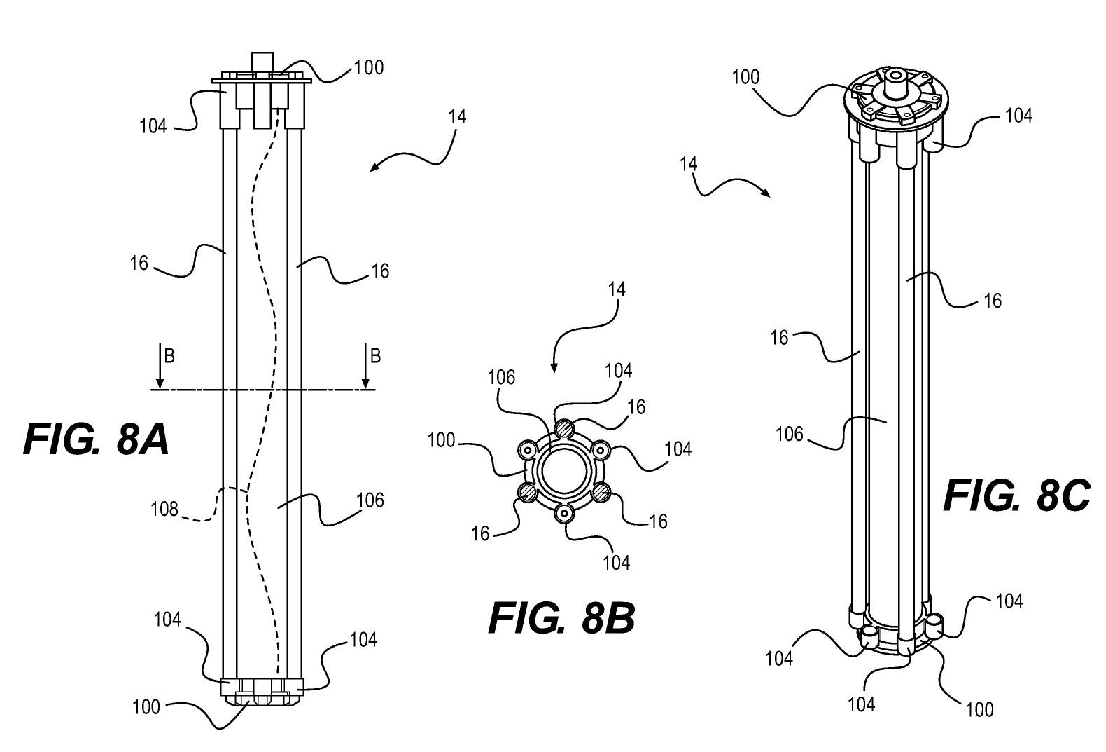

The cathode module 18 can include one or many anodes 16, as it can be appreciated in the embodiment of FIG. 8, which can be individually or collectively be made of Mg, Al, Fe, Ca, or any other suitable material. The anode module 14 is operatively connected to an anode agitation module 24 adapted to rotate, or apply a reciprocal angular motion, the anodes 16 inside the electrocoagulation module 10 in respect with the cathode module 18. It can be appreciated by a skilled reader that consumable and inert (non-consumable) anodes 16 can be collectively used to simultaneously produce electrocoagulation and electroflotation. Also, it can be appreciated that a continuous flow of fluid is desirable for a continuous treatment of the fluid in the electrocoagulation module 10. The rotative motion of the anodes 16 creates a circular and preferably turbulent movement of the fluid in the anode module 14 hence increasing the number of particle collisions in the fluid and thus the kinetic energy contained in the fluid.

An anode module 14 can accommodate a plurality of anodes 16 as embodied in FIGS. 8a) through 8c). The plurality of anodes 16 can serve in different ways the electrocoagulation process. They can be moved to further add kinetic energy to the fluid. They can have different sizes and shapes to provide a better balance between the anode module 14 and the cathode module 18. Also, the anodes 16 can be made of different materials depending of the type of contaminants contained in the fluid to clean because different anodic materials will interact differently with different contaminants and provide further advantages. The distance between the anodes 16 and the cathode module 18 can also be adjusted if desirable.

FIGS. 8a) through 8c) referred above illustrate a general anode module 14 embodiment where two opposed anodes holders 100 provided with a plurality of anode-receiving portions 104 adapted to receive therein an anode's extremity. The two opposed anodes holders 100 are held together by a junction member 106 to form a unitary structure. The junction member 106, to retain the anodes 16 in their respective and opposed anodes holders 100, provides a longitudinal tension. The opposed anodes holders 100 can be disassembled from the junction member to insert the anodes 16 in their respective opposed anode-receiving portions 104. Plastic or other non-conductive materials can be used to manufacture the junction member 106 to prevent electric current to be conducted by the junction member 106 between the anodes holders 100. The non-conductive junction member 106 is unlikely to interfere in the electrolysis process that is occurring only with the anodes 16 in relation with the cathode module 18. An optional conductor, like an electrically conductive wire 108, can be integrated into the junction member 106 to electrically connect the two opposed anodes holders 100 to ensure proper current distribution within the anodes 16 in an embodiment of the invention.

Alternatively, the opposed anodes holders 100 could be made of a non-conductive material in another embodiment. In the later embodiment the conductive wire 108, or any other electrically conductive element would electrically connect the anodes 16. A conductive junction member 106 can be used in embodiments using non-conductive anodes holders 100. The conductive junction member 106 could be used as another cathode providing an electrolytic surface to the anodes 16 on the opposite side of the cathode module 18 to perform a more even electrolysis of the anodes 16.

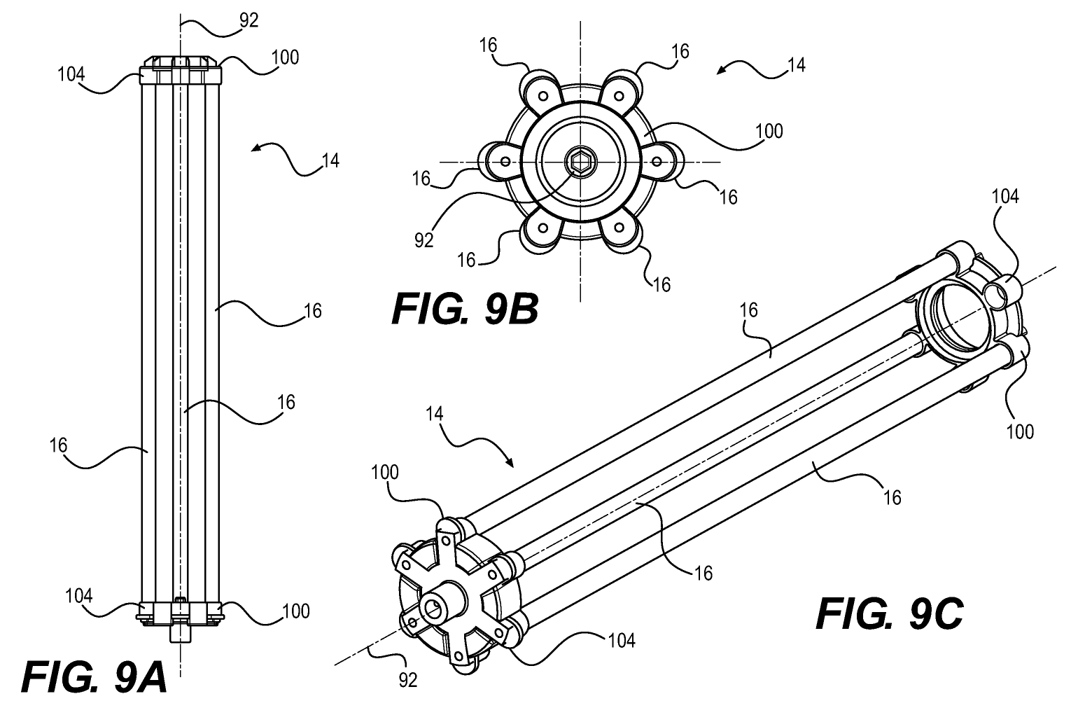

The anode module 14 having a plurality of anodes 16 thereof can be embodied like the anode module 14 illustrated in FIGS. 9a), b) and c). The anode module 14 includes two opposed conductive anodes holders 100 adapted to secure therebetween six anodes 16 (a different number of anodes 16 can be used if desirable). The anode module assembly thus created can be used to rotate, or angularly reciprocate, in the electrocoagulation module 10 to add kinetic energy to the fluid in the electrocoagulation module 10. The anodes holders 100 are sized and designed to easily replace anodes 16 thereon. The anodes holders 100 are also adapted to receive anodes of different shapes, materials and are furthermore adapted to leave some anode-receiving portions 104 empty, as it will be discussed in greater details below.

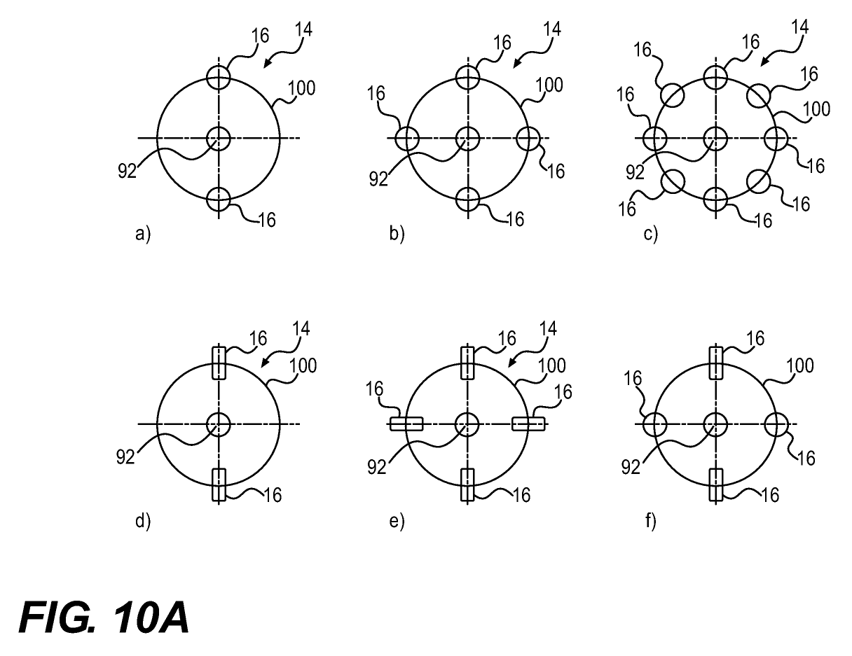

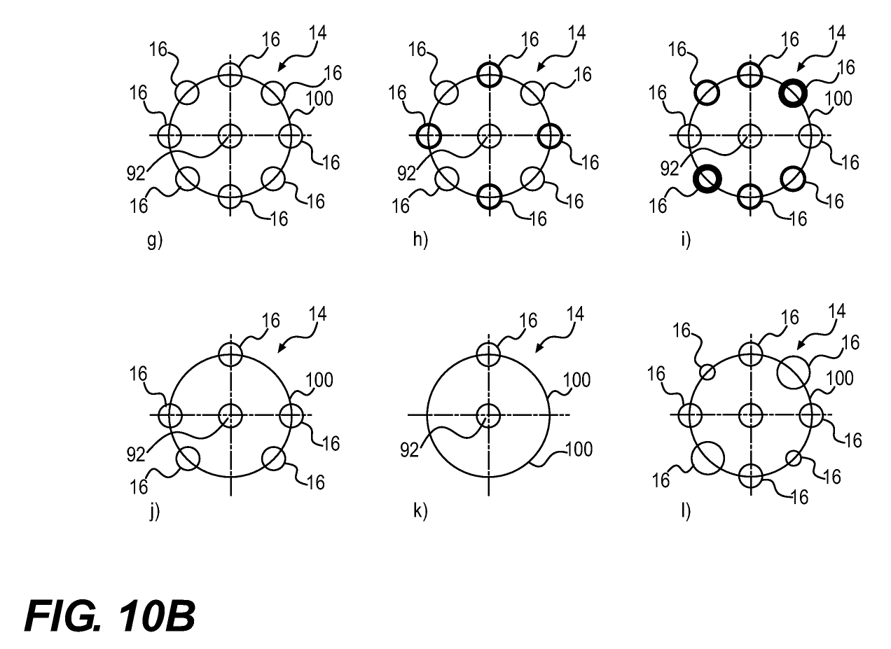

FIG. 10 a) through FIG. 10 I) illustrates a plurality of anode modules 14 with different configurations of anodes 16 thereon. There are many possible variations and some are illustrated with different number of anodes 16, anode sizes (e.g. small, medium, large, thin, thick) and with different shapes. These different anodes holders 100 configurations are presented for illustrative purpose and do not intend to limit the possibilities to the illustrated anode module 14 configurations.

The particularity of the anode module 14 of the illustrated embodiment is that it is designed like a multi-headed anode module 14 with anodes 16 thereon. A different number of anodes 16 and the position of the anodes 16 on the anode module 14 illustrated herein can vary to adjust to the fluid to be treated without departing from the scope of the present invention. The position of the anodes 16 in respect with the cathode module 18 is optionally ensured by insulating supports (not illustrated) in order to avoid uneven wear of the anodes 16. The cathode module's 18 surface area can be larger than the combined surface areas of the anodes 16 to improve electrolytic performance. The cathode 18 surface area might be equal or smaller than the surface area of the anodes 16 by making a reduction of the cathodes' 18 surface area. The design of the cathode module 18 and the anodes 16 included in the anode module 14 depends, inter alia, of the amount of contaminants contained in the fluid and the flow of fluid to be electrocoagulated.

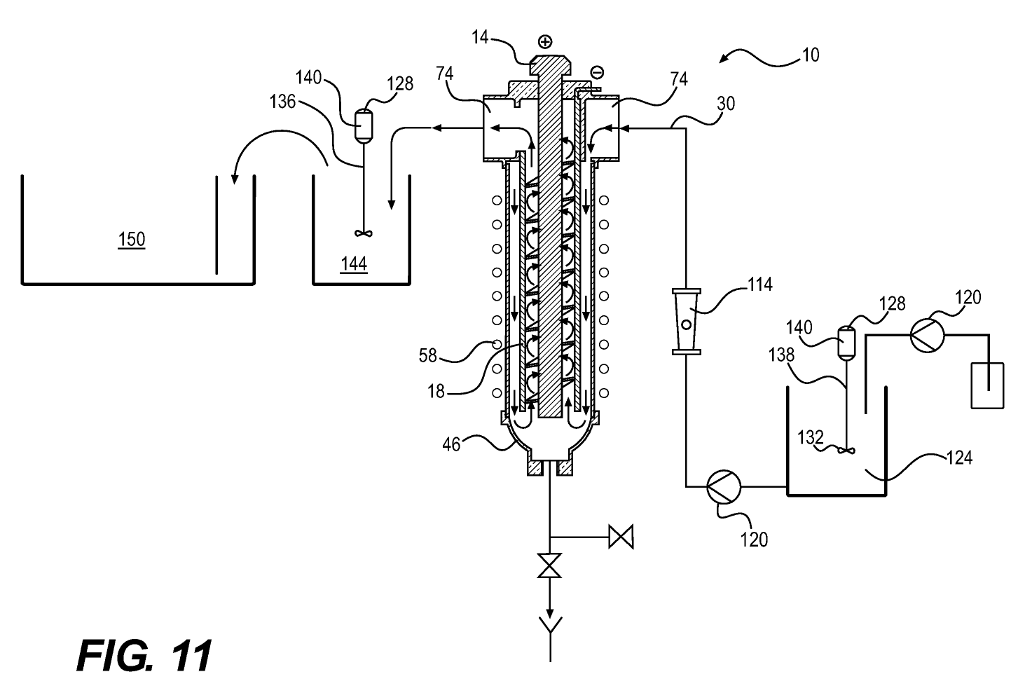

The cathode module 14, or the body 30, includes at least two electrocoagulation module connectors 74 serving as fluid inlets and outlets. The electrocoagulation module connectors 74 can be associated with optional filters 114 adapted to filter particles of filterable sizes as it is illustrated in FIG. 11. The electrocoagulation module 10 connectors 74 can be disposed anywhere on the electrocoagulation module 10. Preferably, the electrocoagulation module connectors 74 are disposed on opposite sides to help prevent direct fluid communication thereof.

The aforementioned electrocoagulation module 10 herein refers to uses consumable electrodes to electrocoagulated colloidal solutions. The same electrocoagulation module 10 can accommodate non-consumable electrodes, passive electrodes (i.e. non-conductive electrode), therein to be transformed into an electroflotation module 12. The electroflotation module 12 produces microbubles in the fluid therein that helps lifting the particles in the fluid. The electrocoagulation module 10 and the electroflotation module 12 can be used separately or in combination in a process. Moreover, electrocoagulation and electroflotation can be obtained in a single reactor by combining consumable and inert anodes 16. The present description used above a single electrocoagulation module 10 for explanation purposes. The text below refers to a process using either a single electrocoagulation module 10 as illustrated in FIG. 11, a single electroflotation module 12, a combination of a plurality of electrocoagulation modules 10, a combination of a plurality of electroflotation modules 12 and a combination of electrocoagulation module(s) 10 and electroflotation module(s) 14. Alternatively a plurality of electrocoagulation modules 10 can be connected in series or parallel depending on the type of liquid and its impurities to be treated. The multiplication of electrocoagulation modules 10 can significantly increase the performance, speed and quality of the treatment. Each module 10, 12 can be associated with a conditioning module 144 and/or a decantation module 150.

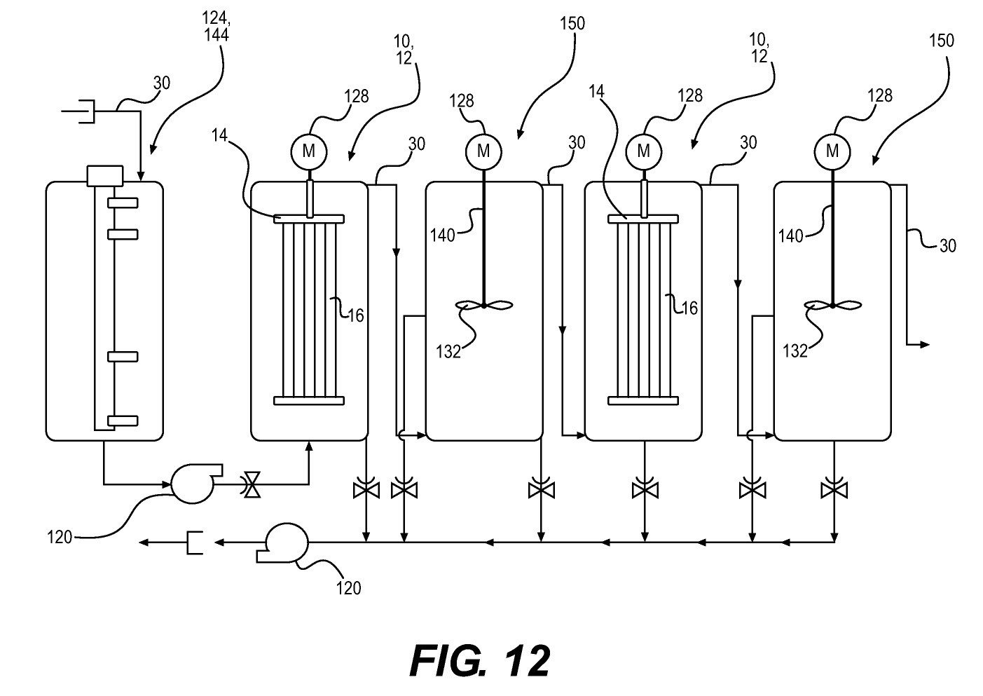

Turning now to FIG. 12 depicting some possible embodiments using an electrocoagulation module 10 in accordance with the present invention directed, inter alia, to the removal of organic particles and inorganic particles, like phosphor. The fluid is pumped 120 into an agitated conditioning reservoir 124 provided with an agitator 128 to remove air from solid particles in a form of micro-bubbles (or to remove gas molecules from solid particles) and then passes through a primary filter 114 prior to be injected into the electrocoagulation module 10. The agitated conditioning reservoir 124 is further equipped with an agitator 128 using blades 132 secured to an end of a rotating shaft 136 rotated by a motor 140. After the fluid is pumped with an optionally adjustable flow pump 114 in the electrocoagulation module 10. The fluid is “energized” by the protrusion members 70 secured to the anode module 14 disposed in the electrocoagulation module 10 as explained in details earlier. Once the fluid has passed through the electrocoagulation module 10 it goes to a conditioning module 144 also provided with an optional agitator 128 using blades 132 secured to an end of a rotating shaft 136 rotated by a motor 140. The conditioning module 144 is used to condition the fluid prior to entering a process phase by homogenising, changing the pH, changing the chemistry of the fluid to improve the reactiveness of the fluid flowing through the electrocoagulation module 10 and/or the electro-flotation module 12. Its volume can illustratively be of about 500-1000 liters per hour and can be provided with a means for homogenize the fluid, a conductivity regulator module (not illustrated) and/or a pH regulator module (not illustrated). The fluid treated thereof is then ready to be used. A fluid analysis module (not illustrated) is alternatively provided at a position along the fluid path in the treatment system to determine the chemical oxygen demand contaminants level contained in the fluid, at that position, treated by the electrolysis system, the fluid analysis module being adapted to include one of an infra-red detector and a turbidity probe.

FIG. 12 illustrate an embodiment directed to the removal of COD particles, suspended solid matter and soluble organic matter. The principle is quite similar to the embodiment illustrated in FIG. 11 with some differences. Namely, there is a plurality of electrocoagulation modules 10 and homogenisation modules 144 operatively disposed in series. The fluid passes through a primary filter (not illustrated) and then reaches a conditioning reservoir 124 and conditioning module 144 prior to be injected into a first electrocoagulation module 10. The fluid is electrocoagulated a first time in the first electrocoagulation module 10 and is released into a first decantation module 150 further equipped with an agitator 140 equipped with blades 132 secured to an end of a rotating shaft 136 rotated by a motor 128. The fluid is optionally precisely pumped with an adjustable flow pump (not illustrated) disposed along the process. A second electrocoagulation module 10 is followed by a second decantation module 150 to remove COD residual particles. The fluid is mixed with rotatable anodes 16 disposed in the electrocoagulation module 10 as explained in details earlier.

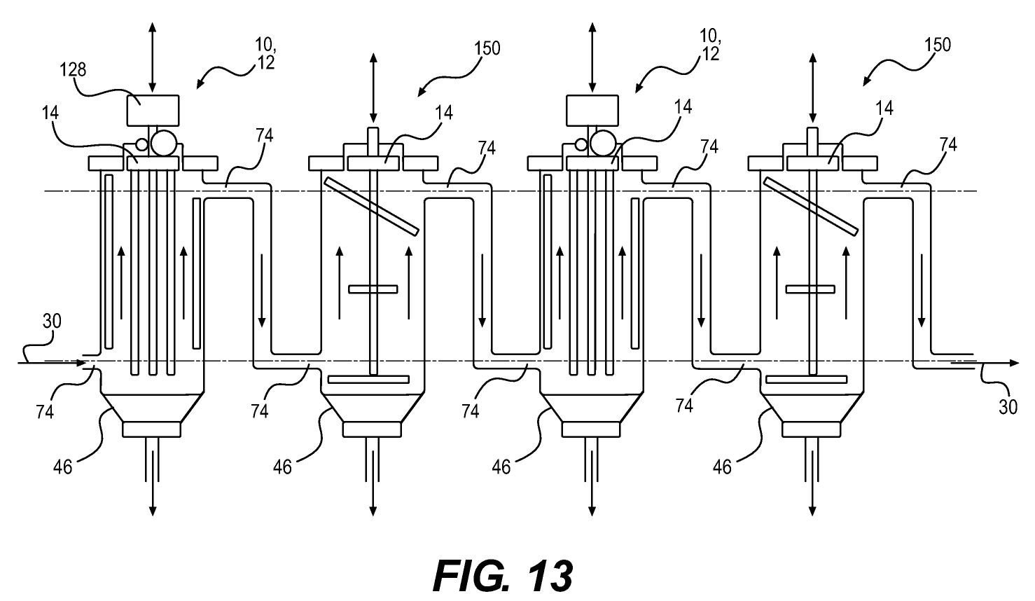

The fluid can be transferred from an electrocoagulation module 10, or an electroflotation module 12, to a decantation module 150 in at least another embodiment as it is illustrated in FIG. 13. The decantation module 150 is preferably equipped with internal routings adapted to help separate particles from the fluid that will be discussed in details below.

FIG. 13 illustrates a series of electrocoagulation modules 10, and/or electroflotation modules 12, and decantation modules 150. One can appreciate that the connectors 74 are vertically at the same height to ensure efficient fluid transfer between the modules 10, 12, 150. It can also be appreciated that the anode module 14 is vertically adjustable to set the length of the anodes 16 in the fluid and adjacent to a corresponding cathode module 18. The same vertical adjustment principle is used in the decantation modules 150 to set the height of the internal routings for proper fluid routing. Once the fluid has passed through an electrocoagulation module 10 it goes to a decanter module 150 to further separate remaining particles. The fluid treated thereof is then extracted from the system.

Finally, FIG. 13 can illustrate an embodiment directed to pre-thickening. The principle still resembles to the embodiment illustrated in FIG. 12 with at least the difference that there is no electro-flotation module 14 and no conditioning modules 144. The last stage of the process with this embodiment consists in removing fluid on a dripping table to separate the particles contained therein, which is not illustrated in FIG. 13.

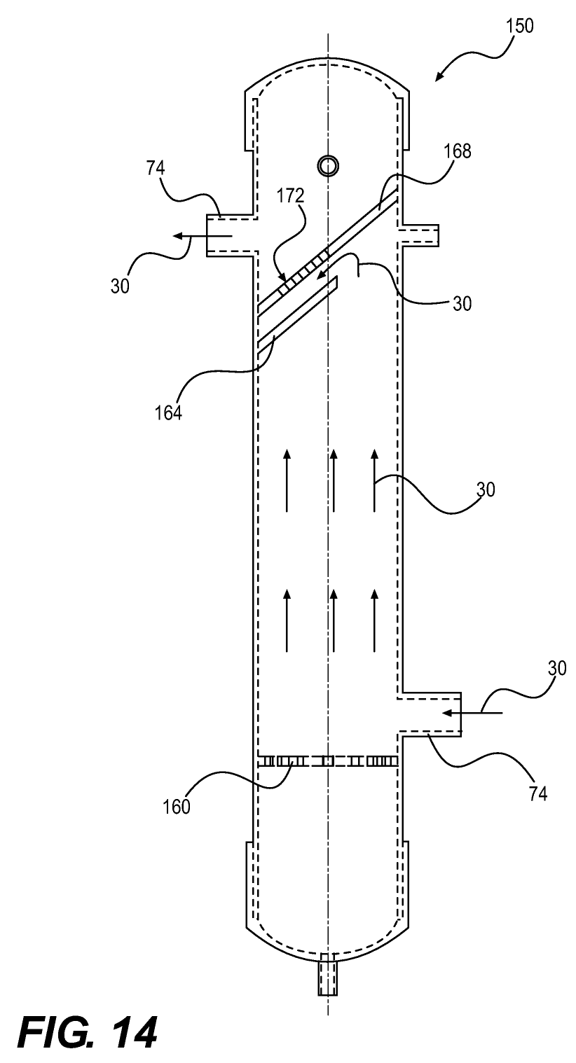

FIG. 14 through FIG. 16 depicts three different embodiments of decanter modules 150. The decanter module 150 is generally used to help separate particles from the fluid. It achieves that by slowing down the fluid, preferably in a laminar flow, to let gravity attract heavier particles to the bottom of the module 150 to be later drained out. More precisely, in respect with FIG. 13, the fluid enters the connector 74 above a punctured separator 160 adapted to let the particles fall through to the bottom of the decanter 150 and also prevent the inbound fluid to carry the particles at the bottom of the decanter 150 aspirated by the flow. The fluid then move up slowly given the larger diameter of the decanter module 150 to pass between two separating plates 164, 168, forming a channel at about 35 degree angle. Separating plate 168 includes a series of holes 172 sized and designed to let the fluid pass through to reach the exit connector 74 without creating turbulence in the fluid lower in the decanter module 150.

A cylindrical centrifugal decanter (not illustrated) of an embodiment of the invention can rotate at about 300 RPM. Such a centrifugal decanter could be provided with internal radial fins secured to a rotatable vertical motor-driven shaft to apply desirable movement to the fluid in the decanter.

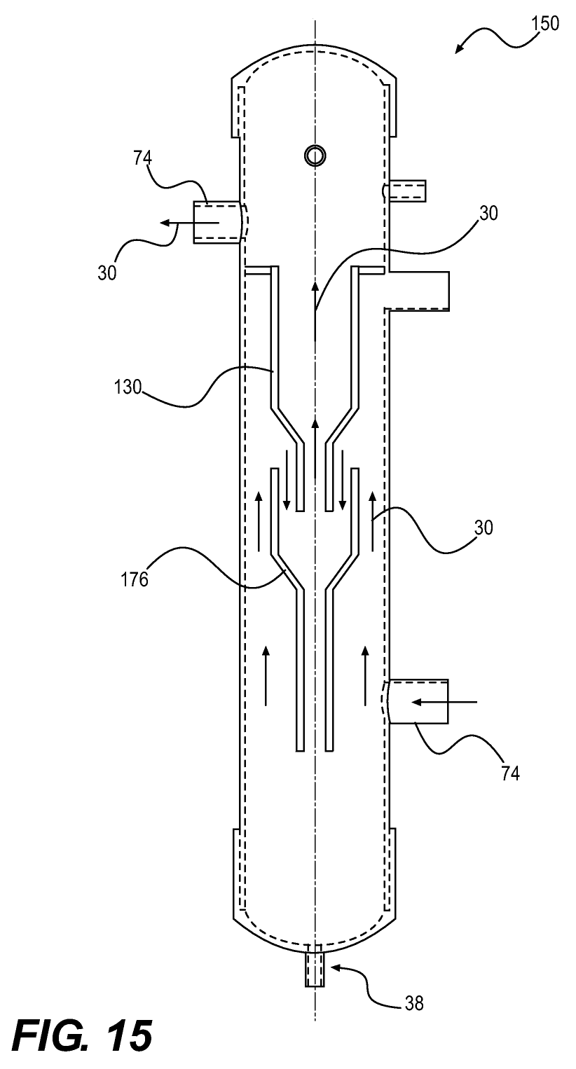

The embodiment illustrated in FIG. 15 uses a different internal structure to help separate the particles from the fluid. The fluid enters the decanter module 150 and as to move upward 30 to get downward into a first funnel-like separator 176 to change direction again upward to enter a second funnel-like separator 180 to finally reach the exit connector 74 above. One can appreciate from that design that the first separator 176 has a hole in its center connected to a tubular portion 184 extending down lower than the entering connector 74 to prevent the entering fluid to bypass the first separator 176 and to allow particles to fall through the first separator 176 to the bottom of the decanter module 150.

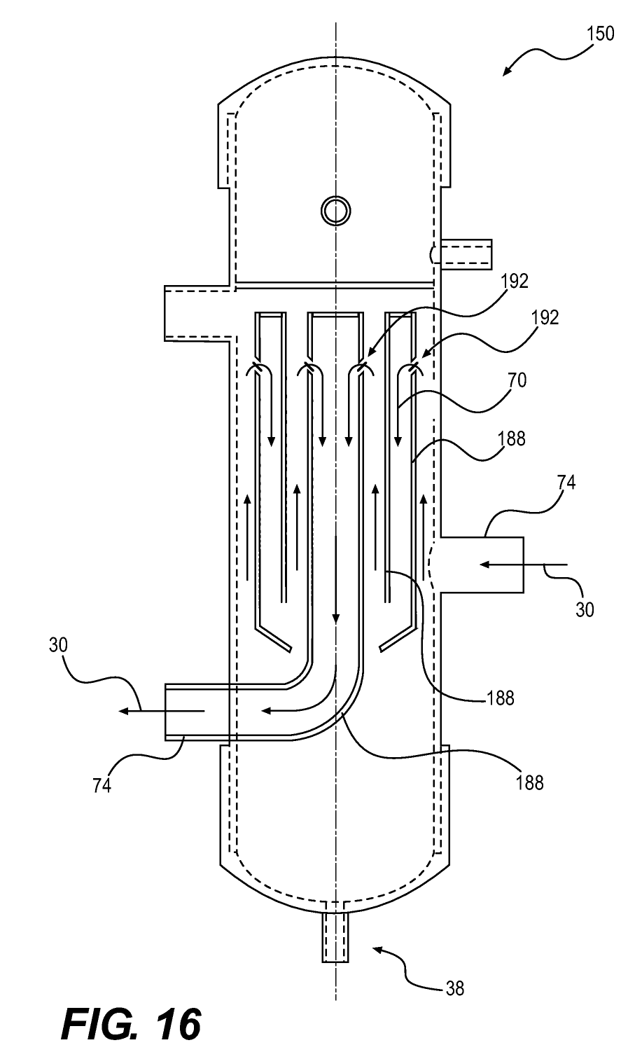

A third decanter 150 embodiment is illustrated in FIG. 16. This embodiment also slows down the flow of fluid to allow heavier particles to fall down in the decanter 150. A number of channels 188 are defined inside the decanter 150, with holes 192 at specific locations, to direct the fluid. It can be appreciated that the entering connector 74 faces a channel's wall and forces the fluid to move upwardly thus allowing the heavier particles to fall at the bottom of the decanter 150. The fluid passes through the holes 192 to get to the second layer of channels 188 to finally move downward to reach exit connector 74. It can also be appreciated that openings 192 are defined in the lower portion of the channels 188 to let particles fall to the bottom of the decanter 150 to later be drained.

While the invention has been described in connection with what is presently considered to be the most practical and preferred embodiments, it is to be understood that the invention is not to be limited to the disclosed embodiments and elements, but, to the contrary, is intended to cover various modifications, combinations of features, equivalent arrangements, and equivalent elements included within the spirit and scope of the appended claims. Furthermore, the dimensions of features of various components that may appear on the drawings are not meant to be limiting, and the size of the components therein can vary from the size that may be portrayed in the figures herein. Thus, it is intended that the present invention covers the modifications and variations of the invention, provided they come within the scope of the appended claims and their equivalents.

1-20. (canceled)

21. A modular electrolysis system for treating fluid for removing colloid contaminants contained therein, the modular electrolysis system comprising an electrocoagulation module including an inlet and an outlet, the electrocoagulation module being adapted to include an anode module comprising at least one anode, a cylindrical cathode module, and an agitation module for performing electrolysis of the fluid in the electrocoagulation module.

22. The modular electrolysis system of claim 21, wherein the electrocoagulation module further comprises a second cathode comprised along the central axis of the module.

23. The modular electrolysis system of claim 21, wherein said agitation module is a fluid agitator module connected to the anode module and facing the cathode, the fluid agitator module being adapted to mechanically agitating the fluid upon its passage in the electrocoagulation module.

24. The modular electrolysis system of claim 21, wherein the agitation module is adapted to move the anode module for agitating the fluid in the electrocoagulation module.

25. The modular electrolysis system of claim 21, wherein the anode module comprises a plurality of anodes equally disposed circularly around the central axis of the anode module.

26. The modular electrolysis system of claim 21, wherein the anode module is removable.

27. The modular electrolysis of claim 26, wherein the electrocoagulation module is adapted to be pivotally mounted about a substantially horizontal axis to allow easy replacement of the anode module contained therein from an upper portion of the electrocoagulation module.

28. The modular electrolysis system of claim 21, wherein the modular electrolysis system further comprises a fluid analysis module adapted to determine the chemical oxygen demand contaminants level contained in the fluid, the fluid analysis module being adapted to include one of an infra-red detector and a turbidity probe.

29. The modular electrolysis system of claim 21, wherein the modular electrolysis system further comprises a fluid flow control adapted to manage the flow of the fluid in the modular electrolysis system.

30. The modular electrolysis system of claim 21, wherein the electrocoagulation module includes an opening for exchanging a gas between the electrocoagulation module and the environment.

31. The modular electrolysis system of claim 21, wherein the modular electrolysis system further comprises a conditioning module fluidly connected therein.

32. The modular electrolysis system of claim 21, wherein the electrocoagulation module is adapted to be at least partially converted in an electro-flotation module by changing the material of the anode of the anode module, the module thus performing at least one of electrocoagulation and electro-floatation.

33. The modular electrolysis system of claim 21, wherein the fluid is substantially routed in the electrocoagulation module from the bottom of the electrocoagulation module to the top thereof.

34. The modular electrolysis system of claim 21, wherein the modular electrolysis system comprises a plurality of electrocoagulation modules including respective inlets and outlets, the inlets being adapted to be located at substantially the same vertical height thereof.

35. The modular electrolysis system of claim 21, wherein the modular electrolysis system comprises a decanter module adapted to decant particles contained in the fluid.

36. A method of treating a colloidal fluid to remove contaminants contained Therein, the method comprising:
injecting the colloidal fluid containing contaminants in an electrolytic system including an electrocoagulation module comprising
an anode; and
a cathode, the anode and the cathode being adapted to electrically connect to perform electrolysis of the fluid;
providing an electric current between the anode and the cathode while the fluid is mechanically agitated in the electrocoagulation module, to form electrocoagulated contaminants flocs in the fluid;
separating the electro-coagulated flocs from the fluid; and
extracting the fluid from the electrolytic system.

37. The method of claim 36, further comprising decanting the fluid with a decanter fluidly connected with the electrocoagulation module.

38. The method of claim 36, further comprising conditioning the fluid with a conditioning module fluidly interconnected with the electrocoagulation module, the conditioning module being adapted to condition the fluid prior to be injected in the electrocoagulation module.

39. The method of claim 36, wherein injecting the fluid in the electrocoagulation module is performed substantially from the bottom of the electrocoagulation module to the top thereof.

40. An electrolysis kit for treating a fluid to remove colloid contaminants contained therein, the kit comprising:
an electrolytic module;
an anode module adapted to be operatively inserted in the electrolytic module;
at least one anode adapted to be assembled to the anode module; and
an agitation module,
the anode material being defined to produce one electrolytic process selected from electrocoagulation and electro-floatation.
